(19) United States
(12) Patent Application Publication
(10) Pub. No.: US 2014/0122146 A1
(43) Pub. Date: May 1, 2014

(54) PRESENTING A STATUS AND ACTION OF AN ASSOCIATED OBJECT

(71) Applicants: Holger Deist, Walldorf (DE); Tina Marseille, Walldorf (DE); Carsten Schmitt, Walldorf (DE); Michael Raich, Walldorf (DE); Armin Friemelt, Walldorf (DE); Marco Eidinger, Walldorf (DE); Hans-Dieter Knoch, Walldorf (DE); Jan Kellmereit, Walldorf (DE); Stephan Schlicker, Walldorf (DE)

(72) Inventors: Holger Deist, Walldorf (DE); Tina Marseille, Walldorf (DE); Carsten Schmitt, Walldorf (DE); Michael Raich, Walldorf (DE); Armin Friemelt, Walldorf (DE); Marco Eidinger, Walldorf (DE); Hans-Dieter Knoch, Walldorf (DE); Jan Kellmereit, Walldorf (DE); Stephan Schlicker, Walldorf (DE)

(21) Appl. No.: 13/661,439

(22) Filed: Oct. 26, 2012

(51) Int. Cl. G06Q 10/06

(52) U.S. Cl. 705/7.15

(57) ABSTRACT

A trip object may be associated with one or more trip phase objects having status indicators and associated actions. A determination may be made for a trip status of the trip object and display data for a representation of the trip object may be outputted. The representation may include a trip status indicator portion that is mapped to a determined status for the trip status and a selectable feature that is mapped to an action that is associated with the determined status.

### BACKGROUND

With expanding businesses and globalization, many employees now travel as part of their job duties and/or incur various expenses in the performance of their job duties. For example, in some instances an employee may need to travel away from their employer's office as part of their job and/or incur costs during other aspects of their job function. In some instances, prior to booking or traveling, an employee may need to request approval for the trip using a trip request. The trip request may include information such as a trip budget, a destination, the length of the trip, etc. Once the trip request is approved, or if no trip request is needed, an employee may book a trip and generate a travel plan. The travel plan may include an itinerary, travel arrangement information, and/or other information relevant to the trip. After the trip is over or, in some instances, during the trip, an expense report may be created to log expenses incurred before, during, and/or after the trip. In some instances, each of these different stages of the trip may be represented by a separate object of a business travel reporting and management application. In other instances, the employer and/or employee may incur expenses without travelling that may involve an expense request, expense reporting, and reimbursement (e.g., a business telephone bill).

### SUMMARY

One implementation relates to a method for presenting business trip information to a user via a trip object. The method may include associating a first trip phase object and a second trip phase object with the trip object. The first trip phase object may include a first status associated with a first action and a second status associated with a second action, and the second trip phase object may include a third status associated with a third action. A determination may be made for a trip status of the trip object. Display data for a graphical user interface may be outputted to display a graphical representation of the trip object that includes a trip status indicator portion and a selectable feature. The selectable feature may be mapped to the first action and the trip status indicator portion may be mapped to the first status when the trip status is determined to correspond to the first status. The selectable feature may be mapped to the second action and the trip status indicator portion may be mapped to the second status when the trip status is determined to correspond to the second status. The selectable feature may be mapped to the third action and the trip status indicator portion may be mapped to the third status when the trip status is determined to correspond to the third status.

Another implementation relates to a system having a tangible computer-readable storage device having instructions and one or more processors configured to execute the instructions to perform several operations. The operations may include receiving a request to create a trip request. A trip object and an expense report may be created in response to the received request. The trip request and expense report may be associated with the trip object. The trip request may include a first status associated with a first action, and the expense report may include a second status associated with a second action. A determination may be made of a trip status for the trip object. Display data for a graphical user interface may be outputted to display a graphical representation of the trip object that includes a trip status indicator portion and a selectable feature. The selectable feature may be mapped to the first action and the trip status indicator portion may be mapped to the first status when the trip status is determined to correspond to the first status. The selectable feature may be mapped to the second action and the trip status indicator portion may be mapped to the second status when the trip status is determined to correspond to the second status.

A further implementation relates to a method for providing a graphical representation of a main object. The method may include associating a first object having a first set of statuses and a first set of actions with the main object. Each status of the first set of statuses may be associated with at least one action of the first set of actions. A second object having a second set of statuses and a second set of actions may be associated with the main object. Each status of the second set of statuses may be associated with at least one action of the second set of actions. A determination may be made of a stage of the main object, and, based on the determined stage, a status of the first set of statuses of the first object or a status of the second set of statuses of the second object may be made. Display data for a graphical user interface may be outputted to display a graphical representation of the trip object that includes a selectable feature. The selectable feature may be mapped to an action associated with the determined status of the first or second object.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example computing device;

FIG. 2 is a block diagram of a system having a plurality of computing devices connected to a server via a network;

FIG. 3 is a block diagram of an example business trip having multiple stages with each stage, having multiple statuses;

FIG. 4 is a block diagram of an example main object having multiple phase objects associated with the main object;

FIG. 5 is a flow diagram of an example method of displaying a relevant status and action for a main object;

FIG. 6 is a flow diagram of another example method of displaying a relevant status and action for a main object; and

FIGS. 7A-7I are block diagrams of an example display of a main object having various status indicators and a selectable feature mapped to various actions.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

The following is merely provided for example purposes with the explicit understanding that the examples described herein will not be used to limit the scope or the meaning of the claims.

In some instances, it may be useful to simplify the presentation of material to a user. For example, some events or sequences may be subdivided into discrete stages. The stages may further include various statuses of the stage and/or may include various actions that may be performed. In some instances, it may be useful to determine and present the most relevant action based on the stage and the status of the event or sequence.

By way of example only, a business trip may involve distinct stages, such as a trip request stage, travel plan stage, and expense report stage. Each of these trip stages may involve a different business object with which a user interacts (e.g., a user interacts with a separate trip request business object, travel plan business object, and expense report business object). It may be useful to present a single object representative of the business trip that a user may interact with to interact with the various underlying objects without separately interacting with the different objects. The business trip object may present a relevant status and an associated action for interacting with the underlying business objects to a user based on the stage of the business trip and the status of the relevant underlying business object. For example, a business object in the trip request stage may present a status of “Trip Request—Draft” and a relevant user action to submit the trip request. Similarly, if a trip request has been approved, e.g., the status is “Trip Request—Approved,” the relevant action may be to book travel arrangements for the business trip (e.g., opening a travel booking application, navigate to a webpage for booking travel arrangements, etc.).

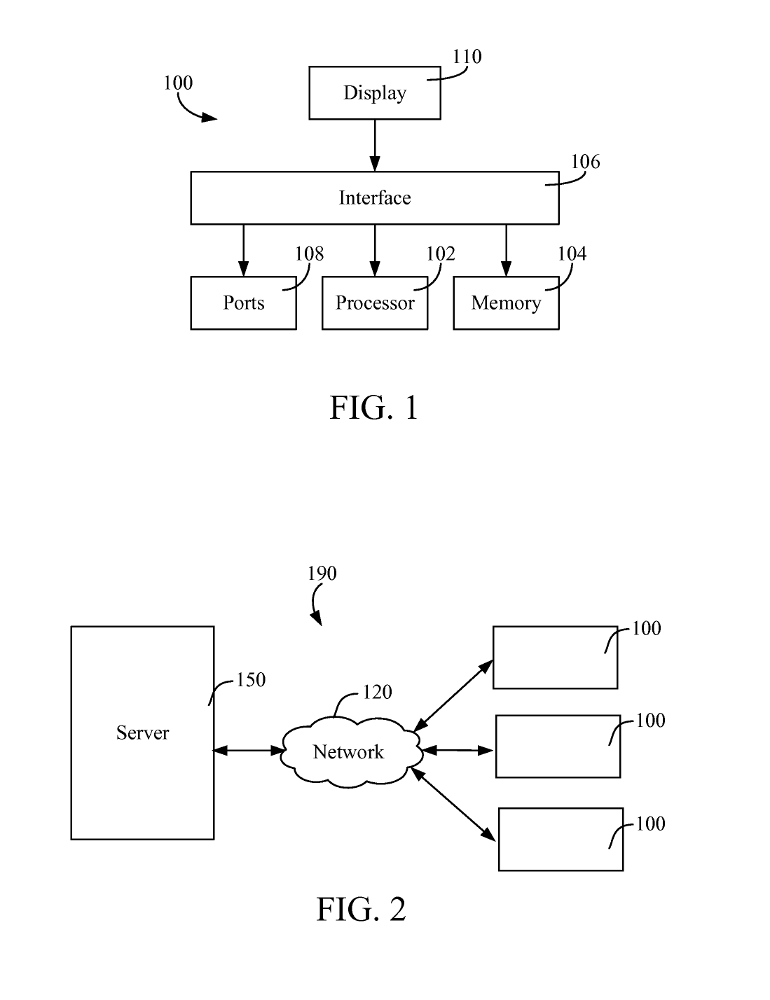

To implement the foregoing, a computing device 100, shown in FIG. 1, may be used in accordance with the implementations described herein, as either a client or as a server or plurality of servers. Computing device 100 may include, but is not limited to, digital computers, such as laptops, desktops, workstations, personal digital assistants, servers, blade servers, mainframes, cellular telephones, smart phones, mobile computing devices (e.g., a notepad, e-reader, tablet, netbook, etc.), etc.

Computing device 100 includes a processor 102, memory 104, an interface 106 and ports 108. Each of the components 102, 104, 106, and 108, are interconnected using various busses, and may be mounted on a common motherboard or in other manners as appropriate. The processor 102 can process instructions for execution within the computing device 100, including instructions stored in the memory 104 to display graphical information for a GUI on an external input/output device, such as display 110 coupled to interface 108.

In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, a multi-processor system, etc.). The ports 108, which may include various communication ports (e.g., USB, Bluetooth, Ethernet, wireless Ethernet, etc.), may be coupled to one or more input/output devices, such as a keyboard, a mouse, a pointing device, a scanner, etc., or a networking device (a switch, adapter, bridge, router, hub, repeater, etc.).

The processor 102 may provide, for example, for coordination of the other components of the device 100, such as control of user interfaces, applications run by device 100, and wireless communication by device 100. Processor 102 may communicate with a user via interface 106 (e.g., control, display, external, etc.), coupled to a display 110. The display 110 may be, for example, a TFT (Thin-Film-Transistor Liquid Crystal Display) display, an OLED (Organic Light Emitting Diode) display, other flexible display, etc. The interface 106 may include circuitry for driving the display 110 to provide graphical, textual, and other information to a user. The interface 106 may receive commands (e.g., voice-activated, text, etc.), from a user and convert them to provide to the processor 102.

In addition, the interface 106 may be provided to communicate with processor 102 and enable near area communication of device 100 with other devices. The interface 106 may provide, for example, for wired communication. In some implementations, multiple interfaces may be used. Computing device 100 may communicate wirelessly through interface 106, which may include digital signal processing circuitry where necessary. Interface 106 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. In addition, GPS (Global Positioning System) receiver module may provide additional navigation- and location-related wireless data to device 100, which may be used as appropriate by applications running on device 100. The device 100 may also be provided with a storage device to provide additional storage, e.g., solid-state flash media. Each of the components may be interconnected using various buses. Several of the components may be mounted on a common motherboard or in other appropriate manners.

The memory 104 stores information within the computing device 100. In one implementation, the memory 104 is a volatile memory unit or units. In another implementation, the memory 104 is a non-volatile memory unit or units. In yet another, the memory 104 comprises both volatile memory units and non-volatile memory units. The memory 104 may also be another form of computer-readable medium, such as a magnetic or optical disk. The memory 104 may be capable of providing mass storage for the computing device 100. In one implementation, the memory 104 may be or contain a computer-readable medium, such as a floppy disk, CD-ROM, DVD, magnetic disk, memory chip, ROM, RAM, EEPROM, EPROM, flash memory or other similar solid state memory device, or an array of devices, including devices in a storage area network or other configurations.

A computer program product may be tangibly embodied in an information carrier. The computer program product may also contain instructions that, when executed, perform one or more methods, such as those described below. The information carrier is a computer or machine-readable medium, such as the memory 104, memory on processor 102, etc. Expansion memory may be provided and connected to device 100 through interface 106.

Referring to FIG. 2, in some versions, a plurality of computing devices 100 may be connected to one or more servers 150 via a network 120 to form a system 190. Network 120 may be any form of computer network that relays information between computing devices 100 and server 150. For example, network 120 may include the Internet and/or other types of data networks, such as a local area network (LAN), a wide area network (WAN), a cellular network, satellite network, or other types of data networks. Network 120 may also include any number of computing devices (e.g., computer, servers, routers, network switches, etc.) that are configured to receive and/or transmit data within network 120. Network 120 may further include any number of hardwired and/or wireless connections. For example, computing devices 100 may communicate wirelessly (e.g., via WiFi, cellular, radio, etc.) with a transceiver that is hardwired (e.g., via a fiber optic cable, a CAT5 cable, etc.) to other computing devices in network 120.

Server 150 may also be any number of different types of electronic devices configured to communicate via network 120 (e.g., a laptop computer, a desktop computer, a tablet computer, a smart phone, a server, combinations thereof, etc.). Server 150 may be configured in substantially the same way as computing device 100 or server 150 may have other configurations. Server 150 may include a processor and a memory, i.e., a processing circuit. The memory may store machine instructions that, when executed by the processor cause the processor to perform one or more of the operations described herein. The processor may include a microprocessor, ASIC, FPGA, etc., or combinations thereof. The memory may include, but is not limited to, electronic, optical, magnetic, or any other storage or transmission device capable of providing the processor with program instructions. The memory may include a floppy disk, CD-ROM, DVD, magnetic disk, memory chip, ROM, RAM, EEPROM, EPROM, flash memory, optical media, or any other suitable memory from which the processor can read instructions.

In some versions, system 190 may be implemented and/or integrated into an enterprise architecture. Of course, system 190 is merely an example and other systems may be used with the methods and processes described herein.

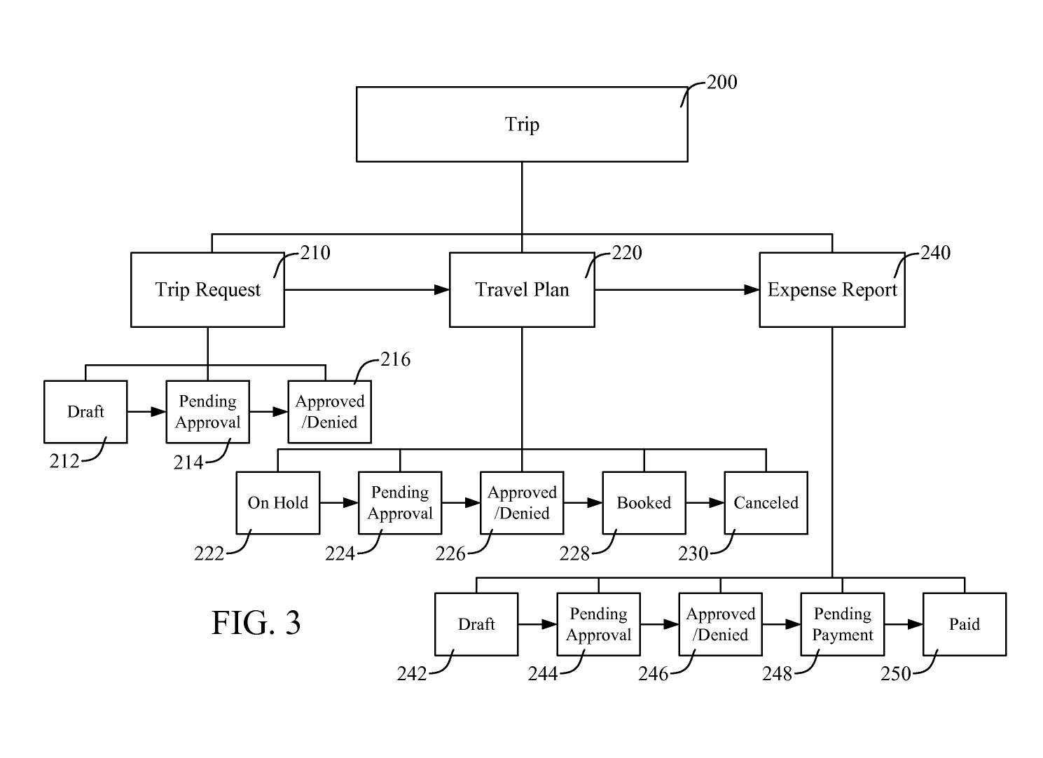

FIG. 3 depicts a block diagram of an example trip 200, such as a business trip, having one or more stages 210, 220, 240. In the present example, the business trip 200 includes three discrete stages: a trip request stage 210, a travel plan stage 220, and an expense report stage 240. In some implementations, one or more of the stages 210, 220, 240 may be excluded and/or more stages may be included. In some implementations, trip 200 may include only a single stage.

During the trip request stage 210, the user may draft a trip request, submit a trip request, await approval of a trip request, have a trip request approved, and/or have a trip request denied. In the example shown, trip request stage 210 of the present example includes a plurality of statuses 212, 214, 216, such as draft 212, pending approval 214, and approved or denied 216. As will be discussed in greater detail below, each status may be associated with a relevant action and/or more than one relevant action. For example, a selectable feature for the relevant action or actions may be provided on a user interface for the user to proceed through the various steps involved in preparing, drafting, and/or submitting the trip request. An action to submit the trip request may be associated with the draft trip request status 212 or an action to view the trip request may be associated with the pending approval status 214. In some implementations, each status 212, 214, 216 may be associated with more than one action, though one action may be the most relevant action for that status 212, 214, 216. In some implementations, if the trip request is denied, the relevant action may be to edit the trip request. In some other implementations, if the trip request is denied, the entire business trip and/or trip request may be deleted such that a user may need to resubmit a new trip request. If the trip request has been approved, the trip 200 may advance to the travel plan stage 220. For instance, once the travel plan stage 210 has an approved status 216, the next step may be to book one or more aspects of the trip (e.g., accommodations, flights, conference rooms, rental vehicles, etc.). In some instances, the travel arrangements may be pre-selected and may be automatically booked upon approval of the trip request.

During the travel plan stage 220, the user may be on hold while awaiting approval of the trip request and/or trip arrangements, book travel arrangements, await approval of travel plans, have travel plans approved, have travel plans denied, and/or have travel plans canceled. In the example shown, travel plan stage 220 of the present example includes a plurality of statuses 222, 224, 226, 228, 230, such as on hold 222, pending approval 224, approved or denied 226, booked 228, and/or canceled 230. As will be discussed in greater detail below, each status may be associated with a relevant action and/or more than one relevant action. For example, a selectable feature for the relevant action or actions may be provided on a user interface for the user to proceed through the various steps involved in booking, submitting, and/or viewing the travel plans. An action to view the travel plans and/or an itinerary may be associated with the pending approval status 224. In some implementations, each status 222, 224, 226, 228, 230 may be associated with more than one action, though one action may be the most relevant action for that status 222, 224, 226, 228, 230. In some implementations, if the travel plan is denied, the relevant action may be to edit the travel plan and/or rebook the travel arrangements. If the travel plan has been approved, a booked status 228 may be indicated and the relevant action may be to view the travel plans and/or an itinerary. In some instances, the trip may be canceled and a canceled status 230 may be indicated and the travel plan and/or itinerary may be deleted or an empty travel plan and/or itinerary may be provided. In some versions, the booked status 228 may be time dependent, i.e., once the travel plan is approved, the booked status 228 may remain so long as the current date is not after the end date of the business trip. Once the end date of the business trip is reached, the trip 200 may advance to the expense report stage 240.

During the expense report stage 230, the user may draft an expense report, submit an expense report, await approval of an expense report, have an expense report approved, have an expense report denied, await payment on an approved expense report, and/or have expenses paid. In the example shown, expense report stage 240 of the present example includes a plurality of statuses 242, 244, 246, 248, 250, such as draft 242, pending approval 244, approved or denied 246, pending payment 248, and/or paid 250. As will be discussed in greater detail below, each status may be associated with a relevant action and/or more than one relevant action. For example, a selectable feature for the relevant action or actions may be provided on a user interface for the user to proceed through the various steps involved in drafting, submitting, and/or viewing the expense report. An action to submit the expense report may be associated with the draft expense report status 242 or an action to view the expense report may be associated with the pending approval status 244. In some implementations, each status 242, 244, 246, 248, 250 may be associated with more than one action, though one action may be the most relevant action for that status 242, 244, 246, 248, 250. In some implementations, if the expense report is denied, the relevant action may be to edit the expense report. If the travel plan has been approved, a pending payment status 248 may be indicated and the relevant action may be to view the approved expense report. Once the expenses have been paid, the status may proceed to the paid status 250. In some instances, when the paid status 250 is indicated the trip 200 may be archived, deleted, and/or otherwise be inactive.

In some implementations, only one status may be active for a given stage. It should be understood that the foregoing is an example and one or more of the statuses may be omitted and/or other statuses may be added to one or more of the stages 210, 220, 240. Furthermore, one or more of the statuses may be rearranged and/or altered as well.

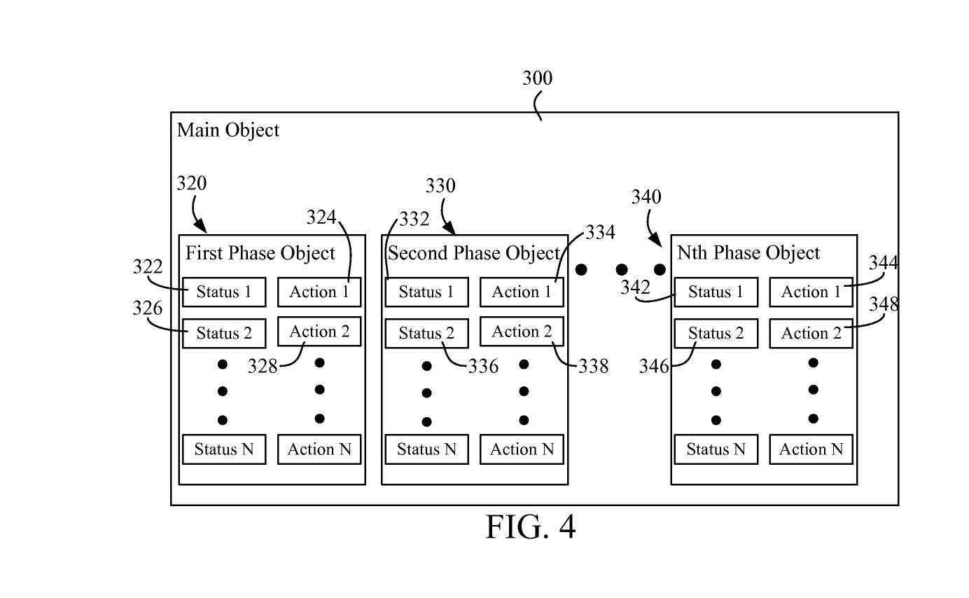

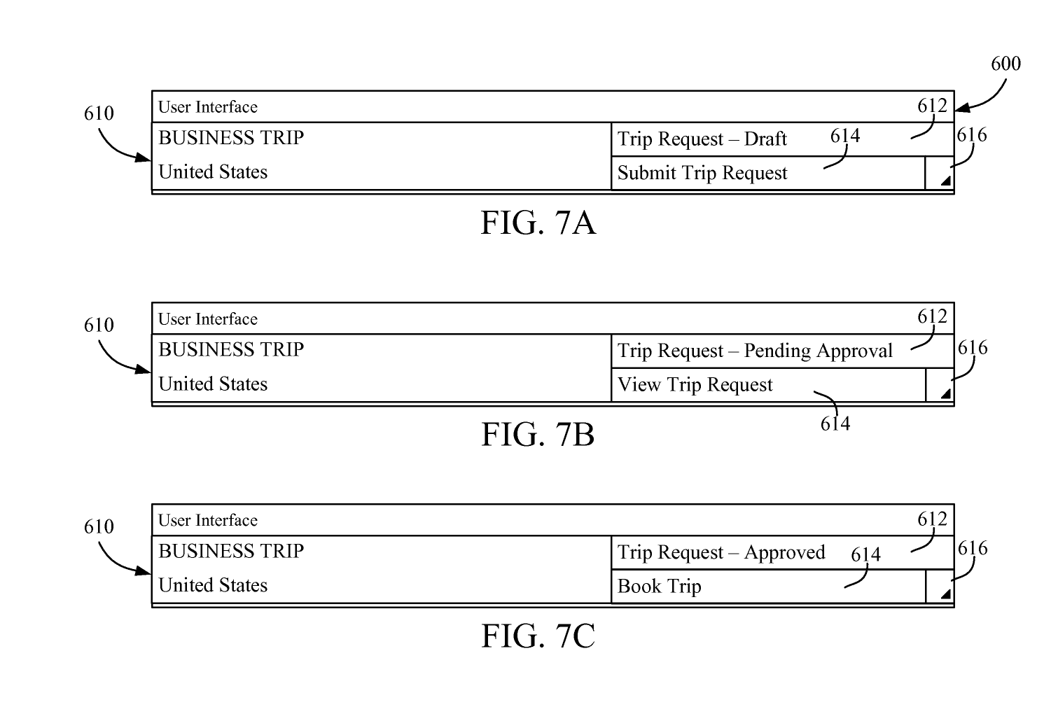

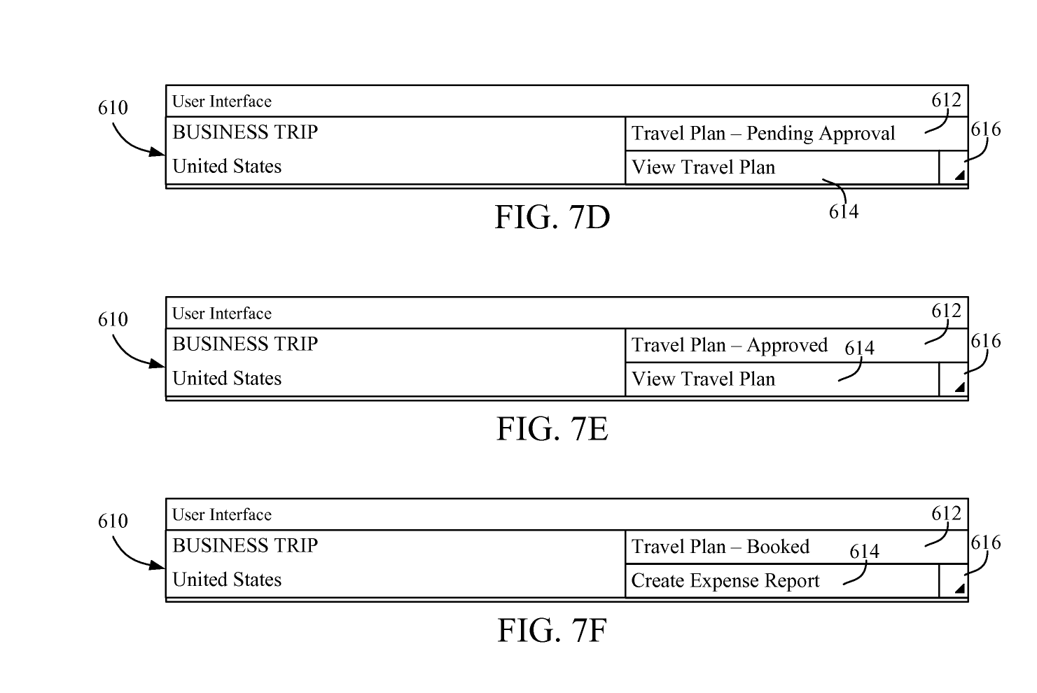

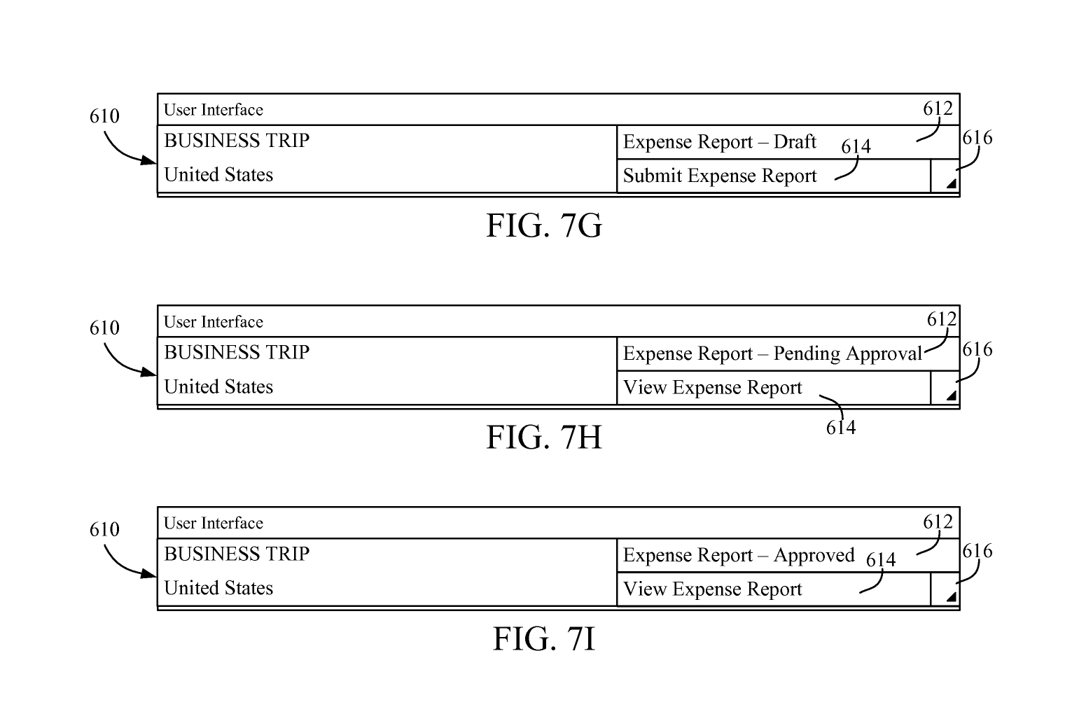

As noted above, it may be useful to present a relevant status and a relevant action for the trip 200 based on the stage 210, 220, 240 of the trip 200 and the status of the stage 210, 220, 240. A user may then seamlessly navigate through the various statuses and stages based on the relevant status and using the relevant action without accessing the backend business objects and/or structures to accomplish the tasks. In an example implementation, such as that shown in FIG. 4, a main object 300 may be provided with which one or more phase objects 320, 330, 340 may be associated. In some instances main object 300 may be a façade object having a set of rules for determining which statuses and/or actions of the one or more phase objects 320, 330, 340 are displayed on a user interface, such as user interface 600 shown in FIG. 7A. For example, the rules may include logic and/or controls for displaying a first status for a status indicator, such as status indicator 612 of FIG. 7A, and mapping a first relevant action to a selectable feature, such as selectable feature 614 of FIG. 7A, when a determination is made that the main object 300 has a status corresponding to the first status. In other implementations, main object 300 may be a self-contained object that incorporates the various statuses and/or actions of the one or more phase objects 320, 330, 340 into the main object 300.

As shown in FIG. 4, the main object 300 may include one or more associated phase objects 320, 330, 340. Each phase object 320, 330, 340 may include one or more statuses 322, 326, 332, 336, 342, 346 and one or more actions 324, 328, 334, 338, 344, 348. For example, first phase object 320 may be a trip request object having a first status 322 of draft, such as draft status 212 of FIG. 3. The first status 322 may be associated with a first relevant action 324, such as an action that submits the trip request. First phase object 320 may include a second status 326 of pending approval, such as pending approval 214 of FIG. 3. The second status 326 may be associated with a second relevant action 328, such as an action that opens an application that displays the trip request and/or otherwise triggers the display of the trip request. Other statuses for the first phase object 320 may be used as well, including, but not limited to draft, pending approval, approved, denied, etc. In addition, the relevant actions may include opening an application to edit or draft a trip request and/or otherwise triggers the editing or drafting of a trip request, copying a trip request, submitting a trip request, opening an application that displays a trip request and/or otherwise triggers the display of a trip request, display a status message (e.g., if a trip request is denied and a reason is provided), creating an expense report, deleting a trip request, etc.

Similarly, a second phase object 330 may be a travel plan object having a first status 332 of pending approval, such as pending approval status 224 of FIG. 3. The first status 332 of the second phase object 330 may similarly be associated with a relevant action 334, such as an action that opens an application that displays a travel itinerary and/or otherwise triggers the display of a travel plan or itinerary. Second phase object 330 may include a second status 336 of booked, such as booked status 228 of FIG. 3. The second status 336 may be associated with a second relevant action 338, such as an action that opens an application that displays the travel plan or travel itinerary and/or otherwise triggers the display of the travel plan or travel itinerary. Other statuses for the second phase object 330 may be used as well, including, but not limited to on hold, pending approval, approved, denied, booked, canceled, etc. In addition, the relevant actions may include opening an application to book travel arrangements, submitting proposed travel arrangements, opening an application that displays the travel plan or travel itinerary and/or otherwise triggers the display of the travel plan or travel itinerary, creating an expense report, deleting a travel plan, etc.

Still further phase objects, such as an Nth phase object 340, may be associated with main object 300. For example, in the business trip context described above, the Nth phase object 340 may be a third phase object having a first status 342 of draft, such as draft status 242 of FIG. 3. The first status 342 of the third phase object may similarly be associated with a relevant action 344, such as an action that opens an application edit or draft an expense report and/or otherwise triggers the editing or drafting of an expense report. The third phase object may include a second status 346 of pending approval, such as pending approval status 244 of FIG. 3. The second status 346 may be associated with a second relevant action 348, such as an action that opens an application that displays and/or permits editing of the expense report and/or otherwise triggers the display and/or editing of the expense report. Other statuses for the third phase object 340 may be used as well, including, but not limited to draft, pending approval, pending approval by manager, pending approval by auditor, approved, denied, pending payment or reimbursement, paid or reimbursed, etc. In addition, the relevant actions may include opening an application to edit or draft an expense report and/or otherwise triggers the editing or drafting of an expense report, opening an application that displays and/or permits editing of an expense report and/or otherwise triggers the display and/or editing of an expense report, copying an expense report, submitting an expense report, recalling a submitted expense report, deleting an expense report, archiving an expense report, etc.

Of course the statuses described herein may be associated with more than one action, though a relevant action may be the action associated with a selectable feature presented on a user interface, as described in greater detail herein. In some instances, the other actions that may be available based upon a determined status may be determined and associated with the main object 300 such that a user may access actions other than those associated with each status. For example, as will be discussed in greater detail below, additional actions may be access via a dropdown menu accessible by a dropdown menu button, such as dropdown menu button 616 shown in FIGS. 7A-7I. In some instances, the actions may be ranked based upon a relevance to the determined status. For example, a main object 300 determined to be in the expense report stage and having a draft status may have a submit action ranked highest, followed by an action to edit the expense report, and followed by deleting the expense report. Thus, the submit action may be associated with the draft status and the other actions may be provided through the dropdown menu.

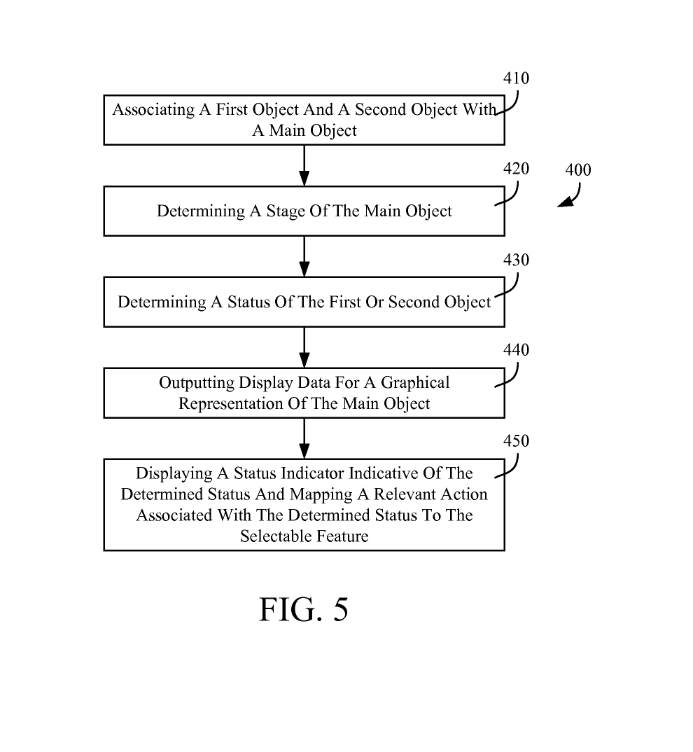

FIG. 5 depicts an example method 400 for associating objects with a main object, such as main object 300 of FIG. 4, and displaying a graphical representation of the main object. A first object and a second object may be associated with the main object (step 410). In some implementations, the first object may include multiple statuses and actions, such as those described above in reference to FIG. 4. Each status may be associated with a relevant action (e.g., a draft status for a first object of a trip request object may be associated with a relevant action of submitting the trip request). The second object may also include multiple statuses and actions, such as those described above in reference to FIG. 4. Each status may also be associated with a relevant action (e.g., a draft status for a second object of an expense report object may be associated with a relevant action of submitting the expense report).

A stage of the main object may be determined (step 420). In the example of a business trip, a trip status may be determined or the like. In some instances, the determination of the stage or trip status may be based on a user interaction (e.g., receiving input indicative of an approval, a submission, and/or the like). In other instances, the determination of the stage may be based on a temporal determination. For example, an expense report stage for a business trip main object may be determined if an end date of the travel plan is in the past relative to the current date. Thus, a displayed status indicator and/or selectable feature may automatically progress to a next status and/or next action based on the temporal determination. The stage determination may be used to determine which phase object, such as a trip request object, travel plan object, expense report object, or the like, is associated with the current stage of the main object.

A status for the phase object associated with the determined stage may be determined (step 430). By way of example only, when a determination is made that a business trip main object is in a stage corresponding to the trip request stage, a determination may be made of the status of the trip request object. For instance, a determination may be made that the trip request has a draft status.

Display data may be output for a graphical representation of the main object (step 440). One example of such a graphical representation of the main object is shown as graphical representation 610 in FIGS. 7A-7I. The graphical representation 610 may include a status indicator portion 612 and a selectable feature 614. Status indicator portion 612 may include textual content (e.g., “Trip Request—Draft”), visual content (e.g., symbols, colors, pictures, or the like), and/or a combination of textual and visual content. For example, a status indicator portion 612 may be “Trip Request—Draft” with the text displayed in white to indicate the draft status. A status indicator portion 612 for “Trip Request—Pending Approval” may be displayed in yellow to indicate the pending approval status. A status indicator portion 612 for “Trip Request—Approved” may be displayed in green to indicate the approved status. Still other textual and/or visual content for status indicator may be used.

The selectable feature 614 may include a single button having text indicating the corresponding action that is mapped to the selectable feature 614, examples of which will be discussed below. Of course, other selectable features 614 other than a single button may be implemented as well.

Text or other indicia for the status indicator portion 612 may be displayed that is indicative of the determined status and a relevant action associated with the determined status may be mapped to the selectable feature (step 450). For example, an example status indicator of “Trip Request—Draft” may be displayed in response to a determination that a business trip object is in the trip request stage and the trip request object has a status of draft. A relevant action associated with the determined status may be mapped to the selectable feature 614, such as a relevant action of submitting the trip request mapped to the selectable feature 614.

In some implementations, the actions available based upon the determined status may be ranked and the top ranked action may be mapped to the selectable feature 614 while the other actions are provided in a dropdown menu accessible via a dropdown menu button 616. For instance, a submit action may be the top ranked action for a draft status when the trip object is in an expense report stage and the submit action may be mapped to the selectable feature 614. Other actions, such as editing the expense report, deleting the expense report, copying the expense report, removing the trip object, etc. may be accessible in the dropdown menu via selection of the dropdown menu button 616.

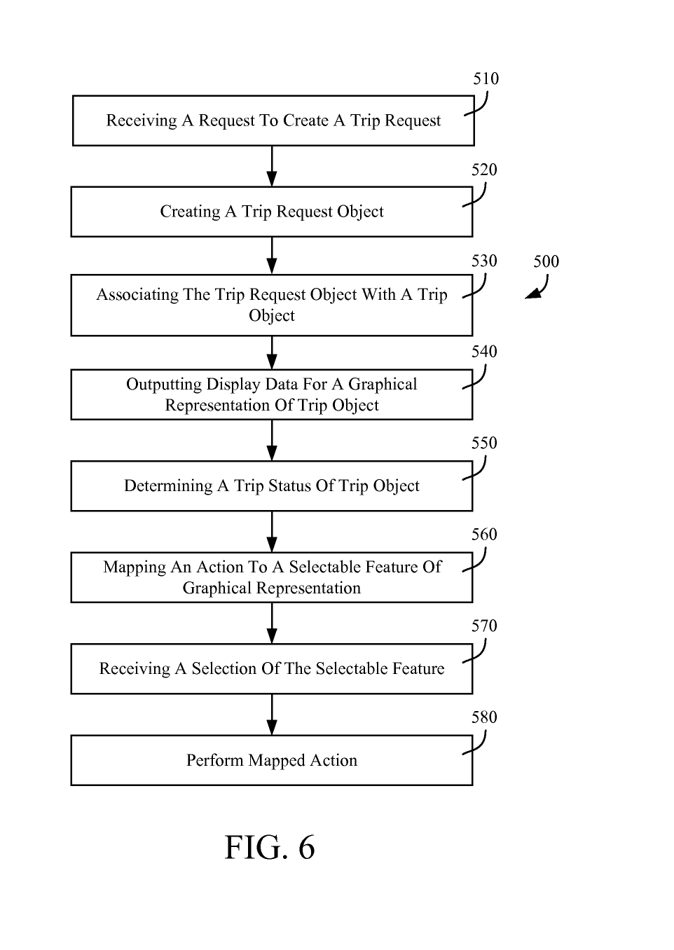

FIG. 6 depicts another example method 500 for a trip object in the business trip context. A request to create a trip request may be received (510). In response to the request to create the trip request, a trip request object may be created (step 520). In some implementations, a trip object, a travel plan object, and/or an expense report object may be created when the trip request object is created and/or requested. The trip request object may be associated with the trip object (step 530). In some implementations, the other created objects, such as the travel plan object and/or expense report object may be associated with the trip object as well.

Display data may be output for a graphical representation of the trip object (step 540). One example of such a graphical representation of the trip object is shown as graphical representation 610 in FIGS. 7A-7I. The graphical representation 610 may include a status indicator portion 612 and a selectable feature 614. Graphical representation 610 and various status indicator portions 612 and selectable feature 614 will be described in greater detail in reference to FIGS. 7A-7I.

A status of the trip object may be determined (step 550). By way of example only, a determination may be made that the status of the trip object is a draft status of the expense report object. Based on the determined status of the trip object, a relevant action associated with the determined status may be mapped to the selectable feature 614 (step 560). For example, the determined status of draft for the trip request object may have a relevant action of submitting the trip request mapped to the selectable feature 614. Of course, other relevant actions may be mapped to the selectable feature 614 for other determined statuses.

In some implementations, a selection of the selectable feature may be received (step 570) and the mapped action may be performed (step 580). In one example, the mapped action may be the creation of a third phase object, such as an expense report object. In response to receiving a selection of the selectable feature, an expense report object may be created.

The foregoing methods 400, 500 may thus be able to provide users with context-relevant interaction options based on the stage and status of a main object. Accordingly, a likely action may be provided to a user via a user interface without navigating through the underlying objects. In addition, the user may perform the action through a single click, thereby increasing usability and/or reducing complexity of the user interface incorporating the graphical representations of the main objects.

FIGS. 7A-7I depict an example user interface 600 having a graphical representation 610 of a trip object and an example sequence that the status indicator 612 and selectable feature 614 may progress through. In some implementations, a dropdown menu button 616 may be provided to access other actions for the trip object. FIG. 7A depicts an example starting graphical representation 610 in which the graphical representation 610 includes a status indicator portion 612 mapped to a draft status of a trip request object of a trip object and a selectable feature 614 mapped to an action for submitting the trip request. The dropdown menu button 616 may provide additional actions other than the action for submitting the trip request, such as editing the trip request, deleting the trip request, copying the trip request, etc. In some instances, the actions may be ranked such that the listing of the actions may be based upon a determined relevance to the current stage and/or status of the trip object.

Once the trip request is submitted, a determination may be made that the trip object is still in the trip request stage and has a status of pending approval. As shown in FIG. 7B, the status indicator portion 612 may be mapped to a pending approval status of the trip request object of the trip object and the selectable feature 614 may be mapped to an action for viewing the trip request.

Once the trip request is approved, a determination may be made that the trip object is in the trip request stage and has a status of approved. As shown in FIG. 7C, the status indicator portion 612 may be mapped to an approved status of the trip request object of the trip object and the selectable feature 614 may be mapped to an action for booking the trip (e.g., opening an application to book travel arrangements, navigating to a web page for booking a trip, and/or the like).

Once the travel arrangements are booked, a determination may be made that the trip object is in the travel plan stage and has a status of pending approval. As shown in FIG. 7D, the status indicator portion 612 may be mapped to a pending approval status of the travel plan object of the trip object and the selectable feature 614 may be mapped to an action for viewing the travel plan.

Once the travel plan is approved, a determination may be made that the trip object is in the travel plan stage and has a status of approved. As shown in FIG. 7E, the status indicator portion 612 may be mapped to an approved status of the travel plan object of the trip object and the selectable feature 614 may be mapped to an action for viewing the travel plan. In some implementations, the trip object may remain in the travel plan stage and approved status until a start date for the trip or event. In such a situation, the trip object may automatically progress to the next status of the travel plan stage.

Once the trip has started, a determination may be made that the trip object is in the travel plan stage and has a status of booked. As shown in FIG. 7F, the status indicator portion 612 may be mapped to a booked status of the travel plan object of the trip object and the selectable feature 614 may be mapped to an action for creating an expense report. In some instances, the selectable feature 614 may remain mapped to the action for viewing the travel plan until an end date of the travel plan and/or any other predetermined date. In some implementations, selection of the selectable feature 614 mapped to an action to create the expense report may create an expense report object and/or associate an expense report object with the trip object. In still further implementations, an expense report object may be automatically created when the end date of the travel plan is reached and/or otherwise.

Once the expense report is created, a determination may be made that the trip object is in the expense report stage and has a status of draft. As shown in FIG. 7G, the status indicator portion 612 may be mapped to a draft status of the expense report object of the trip object and the selectable feature 614 may be mapped to an action for submitting the expense report.

Once the expense report is submitted, a determination may be made that the trip object is in the expense report stage and has a status of pending approval. As shown in FIG. 7H, the status indicator portion 612 may be mapped to a pending approval status of the expense report object of the trip object and the selectable feature 614 may be mapped to an action for viewing the expense report.

Once the expense report is approved, a determination may be made that the trip object is in the expense report stage and has a status of approved. As shown in FIG. 7I, the status indicator portion 612 may be mapped to an approved status of the expense report object of the trip object and the selectable feature 614 may be mapped to an action for viewing the expense report. In some instances, the status indicator portion 612 may be mapped to a pending reimbursement or pending payment status in response to a determination that the trip object is in the expense report stage and has a status of pending reimbursement or pending payment. In some instances, such a status change may occur instead of the approved status and/or otherwise. In some instances, the status indicator portion 612 may be mapped to a paid status in response to a determination that the trip object is in the expense report stage and has a status of paid. In some instances, the selectable feature 614 may be mapped to an action for archiving the trip object, deleting the trip object and/or otherwise.

It should be understood that the foregoing sequence is merely an example and any of the statuses and/or actions may be omitted, rearranged, and/or otherwise. In addition, in some implementations the graphical representation 610 may include a button or other feature to access any of the aforementioned actions such that a user is not necessarily bound to the displayed action of the selectable feature 614. Still further implementations may be used with a main object having one or more phase object and one or more statuses and/or actions.

These computer programs (e.g., programs, software, software applications or code), include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor. A “machine-readable medium” and “computer-readable medium” do not include transitory signals.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for presenting business trip information to a user via a trip object comprising:
associating a first trip phase object and a second trip phase object with the trip object, wherein the first trip phase object includes a first status associated with a first action and a second status associated with a second action, wherein the second trip phase object includes a third status associated with a third action;
determining, by one or more processing modules, a trip status of the trip object; and
outputting display data for a graphical user interface for displaying a graphical representation of the trip object, wherein the graphical representation includes a trip status indicator portion and a selectable feature;
wherein the selectable feature is mapped to the first action and the trip status indicator portion is mapped to the first status when the trip status is determined to correspond to the first status, wherein the selectable feature is mapped to the second action and the trip status indicator portion is mapped to the second status when the trip status is determined to correspond to the second status, and wherein the selectable feature is mapped to the third action and the trip status indicator portion is mapped to the third status when the trip status is determined to correspond to the third status.

2. The method of claim 1, wherein the first trip phase object comprises a trip request and the second trip phase object comprises an expense report.

3. The method of claim 2, wherein the first status is one of draft, pending approval, approved, or denied, and wherein the first action is one of editing the trip request, saving the trip request, copying the trip request, or submitting the trip request.

4. The method of claim 2, wherein the first status is draft, wherein the first action is submitting the trip request, wherein the second status is pending approval, and wherein the second action is opening an editor for editing the trip request.

5. The method of claim 2, wherein the third status is one of draft, pending approval, approved, denied, pending payment, or paid, wherein the third action is one of saving the expense report, editing the expense report, copying the expense report, or submitting the expense report.

6. The method of claim 2, wherein the third status is draft, and wherein the third action is submitting the expense report.

7. The method of claim 1 further comprising associating a third trip phase object with the trip object, wherein the third trip phase object includes a fourth status associated with a fourth action.

8. The method of claim 7, wherein the first trip phase object is a trip request, wherein the second trip phase object is a travel plan, wherein the third trip phase object is an expense report, wherein the wherein the first status is draft, wherein the first action is submitting the trip request, wherein the second status is approved, wherein the second action is opening an application for booking a trip, wherein the third status is booked, wherein the third action is displaying an itinerary, wherein the fourth status is draft, and wherein the fourth action is submitting the expense report.

9. The method of claim 1, wherein the trip status is determined to correspond to the third status based on a temporal determination.

10. The method of claim 1, wherein the trip status is determined to correspond to the third status in response to receiving a user interaction.

11. The method of claim 1, wherein the selectable feature comprises a single button.

12. The method of claim 1, wherein the trip object is created in response to receiving a request to create the first trip phase object.

13. The method of claim 1 further comprising:
receiving a selection of the selectable feature when the selectable feature is mapped to the third action; and
creating a third trip phase object in response to the selection.

14. A system comprising:
a tangible computer-readable storage device comprising instructions; and
one or more processors coupled to the tangible computer-readable storage device and configured to execute the instructions to perform operations comprising:
receiving a request to create a trip request;
creating a trip object and an expense report in response to the received request;
associating the trip request and the expense report with the trip object, wherein the trip request includes a first status associated with a first action, wherein the expense report includes a second status associated with a second action;
determining a trip status of the trip object; and
outputting display data for a graphical user interface for displaying a graphical representation of the trip object, wherein the graphical representation includes a trip status indicator portion and a selectable feature;
wherein the selectable feature is mapped to the first action and the trip status indicator portion is mapped to the first status when the trip status is determined to correspond to the first status, and wherein the selectable feature is mapped to the second action and the trip status indicator portion is mapped to the second status when the trip status is determined to correspond to the second status.

15. The system of claim 14, wherein the first status is one of draft, pending approval, approved, or denied, wherein the first action is one of editing the trip request, saving the trip request, viewing the trip request, copying the trip request or submitting the trip request, wherein the second status is one of draft, pending approval, approved, denied, pending payment, or paid, wherein the second action is one of saving the expense report, editing the expense report, copying the expense report, or submitting the expense report.

16. The system of claim 14, wherein the trip status is determined to correspond to the second status based on a temporal determination or in response to receiving a user interaction.

17. The system of claim 14, wherein the selectable feature comprises a single button.

18. A method for providing a graphical representation of a main object comprising:
associating a first object with the main object, wherein the first object includes a first plurality of statuses and a first plurality of actions, wherein each status of the first plurality of statuses is associated with at least one action of the first plurality of actions;
associating a second object with the main object, wherein the second object includes a second plurality of statuses and a second plurality of actions, wherein each status of the second plurality of statuses is associated with at least one action of the second plurality of actions;
determining a stage of the main object;
determining, based on the determined stage of the main object, a status of the first plurality of statuses of the first object or of the second plurality of statuses of the second object;
outputting display data for displaying a graphical representation of the main object, wherein the graphical representation includes a selectable feature;
wherein the selectable feature is mapped to an action associated with the determined status of the first or second object.

19. The method of claim 18, wherein the selectable feature comprises a single button.

20. The method of claim 18, wherein the graphical representation includes a status indicator portion, wherein the status indicator portion is mapped to the determined status.
